(19) United States
(12) Patent Application Publication
(10) Pub. No.: US 2026/0017223 A1
(43) Pub. Date: Jan. 15, 2026

(54) System and Methods for Multiple PCIe Hosts to Share MFD Devices with Standard Host Drivers

(71) Applicant: Microchip Technology Inc., Chandler, AZ (US)

(72) Inventors: Pragash Mangalapandian, Chennai (IN); Prasanna Vengateshan Varadharajan, Chennai (IN); Atish Ghosh, Austin, TX (US); Kumaravel Thiagarajan, Chennai (IN)

(73) Assignee: Microchip Technology Inc., Chandler, AZ (US)

(21) Appl. No.: 19/252,288

(22) Filed: Jun. 27, 2025

(30) Foreign Application Priority Data
Jul. 11, 2024 (IN) 202411053123

(51) Int. Cl. G06F 13/42

(52) U.S. Cl. CPC G06F 13/4221; G06F 2213/0026

(57) ABSTRACT

A system may include a plurality of hosts coupled to respective PCIe ports, and the system may be coupled to a multi-function device (MFD). The apparatus may be coupled to one or more PCIe devices. The system may include a control circuit, the control circuit to enable an MFD sharing port to allow access to the MFD by the plurality of hosts. Individual hosts may have exclusive access to one or more portions of the MFD and the access of one host may be non-transparent to all other hosts.

### PRIORITY

The present disclosure claims priority to Indian Application No. 202411053123 filed Jul. 11, 2024, the contents of which are hereby incorporated in their entirety.

### TECHNICAL FIELD

The present disclosure relates to electronic devices such as computers sharing device resources and, more particularly, to a system for multiple Peripheral Component Interconnect Express (PCIe) hosts to share multi-function devices (MFD) with standard host drivers.

### BACKGROUND

For multiple PCIe hosts to share MFDs devices, some solutions may use complex virtual intermediary software running on a given host, or a complex fabric mode switch which supports and manages an interconnect of multiple PCIe switches and devices to multiple hosts.

For example, one solution is to use Microchip Switchtec PAX Advanced Fabric PCIe Switch. PAX Fabric switches can be over-featured and cost prohibitive in some applications and it involves more computing resources including RAM, translation tables and proprietary routing of PCIe transactions.

In another example, there might be specialized software running on respective hosts. This software is sometimes referred to as a Virtual Intermediary (VI). The VI software makes sure the processors of the various hosts work cooperatively, and that one host does not interfere with the operation of others. The VI software for a given operating system (OS) is unique for that given OS that the VI software may be running upon. Thus, a version of the VI software may be needed for every OS that might be used in various hosts sharing the MFD. Since behavior is based on cooperation, if one processor of a first host fails and writes into the space of a processor of a second host, problems may ensue.

Examples of the present disclosure may address one or more of these issues.

### BRIEF DESCRIPTION OF THE FIGURES

FIG. 1 is an illustration of a system to share a MFD to hosts simultaneously, according to examples of the present disclosure.

FIG. 2 is an illustration of operation of the system to configure and manage physical functions and provide access to the physical function in a MFD, according to examples of the present disclosure.

FIG. 3 is an illustration of operation of the system to emulate physical functions as individual PCIe devices to hosts to share a MFD to multiple hosts simultaneously, according to examples of the present disclosure.

FIG. 4 is an illustration of operation of a control circuit to bridge requests from a given MFD, according to examples of the present disclosure.

FIG. 5 is an illustration of operation of the control circuit to handle communication from a given host, according to examples of the present disclosure.

FIG. 6 is another illustration of operation of the control circuit to handle communication from a given host, according to examples of the present disclosure.

FIG. 7 is an illustration of operation of the control circuit to handle communication from a respective physical function, according to examples of the present disclosure.

FIG. 8 is another illustration of operation of the control circuit to handle communication from a respective physical function, according to examples of the present disclosure.

FIG. 9 is a more detailed illustration of a bridge, according to examples of the present disclosure.

FIG. 10 is an illustration of an example method, according to examples of the present disclosure.

FIG. 11 is an illustration of an example article of manufacture and an example method performed by such an article of manufacture, according to examples of the present disclosure.

FIG. 12 is an illustration of a method that may be a more detailed illustration of the method of FIG. 11, according to examples of the present disclosure.

FIG. 13 is an illustration of operation of the control circuit to handle configuration read requests from a given host to a logical function, according to examples of the present disclosure.

FIG. 14 is an illustration of operation of the control circuit to handle configuration write requests from a given host to a logical function, according to examples of the present disclosure.

### SUMMARY

The examples herein enable systems and methods for multiple Peripheral Component Interconnect Express (PCIe) hosts to share multi-function devices (MFD) with standard host drivers

According to one aspect, a system includes a plurality of upstream PCIe ports, a given upstream PCIe port to connect to a given host of a plurality of hosts. The system includes a first downstream PCIe port to connect to a multi-function device (MFD), the MFD to be shared by the plurality of hosts. The system to provide access to a plurality of physical functions (PF) of the MFD as a plurality of logical functions (LF) in individual PCIe devices to the plurality of hosts. The system includes a control circuit configured to: enumerate the MFD, emulate a first PF of the plurality of PFs of the MFD as a first individual PCIe device to a first host of the plurality of hosts, the first host connected to the system through a first upstream PCIe port of the plurality of upstream PCIe ports, to emulate a second PF of the plurality of PFs of the MFD as a second individual PCIe device to a second host of the plurality of hosts, the second host connected to the system through a second upstream PCIe port of the plurality of upstream PCIe ports, and to implement inter-domain bridging of PCIe transactions between the plurality of hosts and the plurality of PFs of the MFD.

Aspects in the preceding two paragraphs provide a system, wherein the control circuit is to share the MFD to the plurality of hosts simultaneously while indicating to respective hosts of the plurality of hosts that the given host has control over a given LF.

Aspects in at least one of the preceding three paragraphs provide a system, wherein the control circuit is configured to provide non-transparent access to the MFD for the plurality of hosts through the LFs.

Aspects in at least one of the preceding four paragraphs provide a system, wherein the control circuit is configured to provide non-transparent access to the MFD for the plurality of hosts through the LFs and wherein: the first host is configured to access the first upstream PCIe port in a first partition of the system; the second host is configured to access the second upstream PCIe port in a second partition of the system; and the control circuit is configured to enumerate the MFD from a third partition, internal to the system, wherein the first partition, the second partition, and the third partition of the system are separate partitions, and wherein the control circuit is configured to provide non-transparent access to the MFD for the plurality of hosts through the LFs.

Aspects in at least one of the preceding five paragraphs provide a system, wherein the first host is configured to access a second downstream PCIe port in the first partition of the system to access a downstream device.

Aspects in at least one of the preceding six paragraphs provide a system, wherein the control circuit is configured to implement an inter-domain PCIe bridge to route PCIe signals between a given host to a respective given PF of the MFD through the third partition.

Aspects in at least one of the preceding seven paragraphs provide a system, wherein the control circuit is configured to bridge or emulate configuration access requests from a given host to a respective given PF of the MFD through the third partition.

Aspects in at least one of the preceding eight paragraphs provide a system, wherein the control circuit is configured to: determine whether a request originating from the MFD is a request that pertains to features controlled by a control PF, wherein the control PF is a PF that is configured to control and mange one or more features of other functions in a MFD and based on a determination that the request originating from the MFD is a request that pertains to features controlled by the control PF, handling the request within the third partition and based on a determination that the request originating from the MFD is not a request that pertains to features controlled by the control PF, bridging the request to a respective host.

Aspects in at least one of the preceding nine paragraphs provide a system, wherein the control circuit is configured to do one or more of: determine a first requester identifier and a first completer identifier of a first transaction layer packet (TLP) to bridge a configuration access request from a given host of the plurality of hosts to a respective PF of the MFD through the third partition, determine a memory address, a second requester identifier, and a second completer identifier of a second TLP to bridge a first memory access, a first message, and a first completion from the given host of the plurality of hosts to the respective PF of the MFD through the third partition, determine a third requester identifier of a third TLP to bridge a second memory access and a second message from the respective PF of the MFD to the given host of the plurality of hosts through the third partition, and determine a fourth requester identifier and a third completer identifier of a fourth TLP to bridge a second completion from the respective PF of the MFD to the given host of the plurality of hosts through the third partition.

Aspects in at least one of the preceding ten paragraphs provide a system, wherein the control circuit is to handle a configuration read request from a given host to a respective LF through: determination of whether requested configuration data is to be based on input from one or more of a local storage, Control PF of the MFD for the respective configuration, or a respective PF of the MFD based on a configuration register address in the configuration read request, and to perform one or more of: retrieve configuration emulation data stored in a local storage for processing in a data processor based on a determination that the requested configuration data is to use input from local storage; retrieve first configuration data from Control PF of the MFD for the respective configuration for processing in data processor based on a determination that the requested configuration data is to use input from Control PF of the MFD; and retrieve second configuration data from the respective PF of the MFD for processing in data processor based on the determination that the requested configuration data is to use input from respective Function of the MFD, and process one or more of configuration emulation data, first configuration data, or second configuration data to generate processed configuration data and return the processed configuration data for multi-host emulation of the MFD to the given host, bridging through the respective LF, and update non-transparent bridging rules.

Aspects in at least one of the preceding eleven paragraphs provide a system, wherein the control circuit is to handle a configuration write request from a given host to a respective LF through: determination of whether configuration data is to be written based on input from one or more of a local storage, Control PF of the MFD for the respective configuration, or a respective PF of the MFD based on a configuration register address in the configuration write request and to perform one or more of: retrieve configuration emulation data stored in a local storage for processing in a data processor based on a determination that the configuration data to be written is to use input from local storage, retrieve first configuration data from Control PF of the MFD for the respective configuration for processing in data processor based on the determination that the configuration data to be written needs input from Control PF of the MFD, and retrieve second configuration data from respective Function of the MFD for processing in data processor based on the determination that the configuration data to be written is to use input from the respective PF of the MFD, and process one or more of the configuration emulation data, first configuration data, or the second configuration data of the respective PF in the data processor to finalize the processed configuration data, write the processed configuration data to one or more of local storage, Control PF of the MFD for the respective configuration, and respective PF of the MFD if the configuration register address addresses a valid register supported by respective LF, use processed configuration data for multi-host emulation of the MFD to the given host, bridging through the respective LF, return a completion status to the given host through the respective LF, and update non-transparent bridging rules.

According to one aspect, a method includes steps of: connecting to a given host of a plurality of hosts through plurality of upstream PCIe ports, enumerating, through a first downstream PCIe port connected to a multi-function device (MFD), the MFD, wherein the MFD is to be shared by the plurality of hosts, and the method includes providing access to a plurality of physical functions (PF) of the MFD as a plurality of logical functions (LF) in individual PCIe devices to the plurality of hosts, emulating a first PF of the plurality of PFs of the MFD as a first individual PCIe device to a first host of the plurality of hosts, the first host connected to the apparatus through a first upstream PCIe port of the plurality of upstream PCIe ports, emulating a second PF of the plurality of PFs of the MFD as a second individual PCIe device to a second host of the plurality of hosts, the second host connected to the apparatus through a second upstream PCIe port of the plurality of upstream PCIe ports, and implementing inter-domain bridging of PCIe transactions between the plurality of hosts and the plurality of PFs of the MFD.

Aspects as in the preceding paragraph provide a method, comprising emulating the first and second PFs of the MFD as the first and second individual PCIe devices, respectively, to the plurality of hosts to share the MFD to the plurality of hosts simultaneously.

Aspects as in at least one of the preceding two paragraphs provide a method, comprising sharing the MFD to the plurality of hosts simultaneously while indicating to respective plurality of hosts that the given host has control over a given LF.

Aspects as in at least one of the preceding three paragraphs provide a method, comprising providing non-transparent access to the MFD for the plurality of hosts through the LFs.

Aspects as in at least one of the preceding four paragraphs provide a method, wherein the first host is configured to access the first upstream PCIe port in a first partition of the apparatus, the second host is configured to access the second upstream PCIe port in a second partition of the apparatus, and the method comprises enumerating the MFD from a third partition, internal to the apparatus, wherein the first partition, the second partition, and the third partition of the apparatus are separate partitions.

Aspects as in at least one of the preceding five paragraphs provide a method, wherein the first host is configured to access a second downstream PCIe port in the first partition of the apparatus to access a downstream device.

Aspects as in at least one of the preceding six paragraphs provide a method, comprising implementing an inter-domain PCIe bridge to route PCIe signals between a given host to a respective given PF of the MFD through the third partition.

Aspects as in at least one of the preceding seven paragraphs provide a method, comprising emulating or bridging configuration access requests from a given host to a respective given PF of the MFD through the third partition.

### DETAILED DESCRIPTION

The present disclosure relates to electronic device networking and, more particularly, to a system for multiple PCIe hosts to share MFDs with standard host drivers. The complexity of multiple hosts sharing functions of MFDs may be abstracted in, for example, hardware (HW) and firmware (FW) implementations. A virtual intermediary software component might not be needed compared to other solutions.

Examples of the present disclosure may allow multiple PCIe host processors to share MFDs and the physical functions therein without using specialized host software, and without impacting data throughput. Compared to other solutions, this may provide a lower cost than a fabric-based switch. Furthermore, complex virtual intermediary software might not be required to be running on the host system.

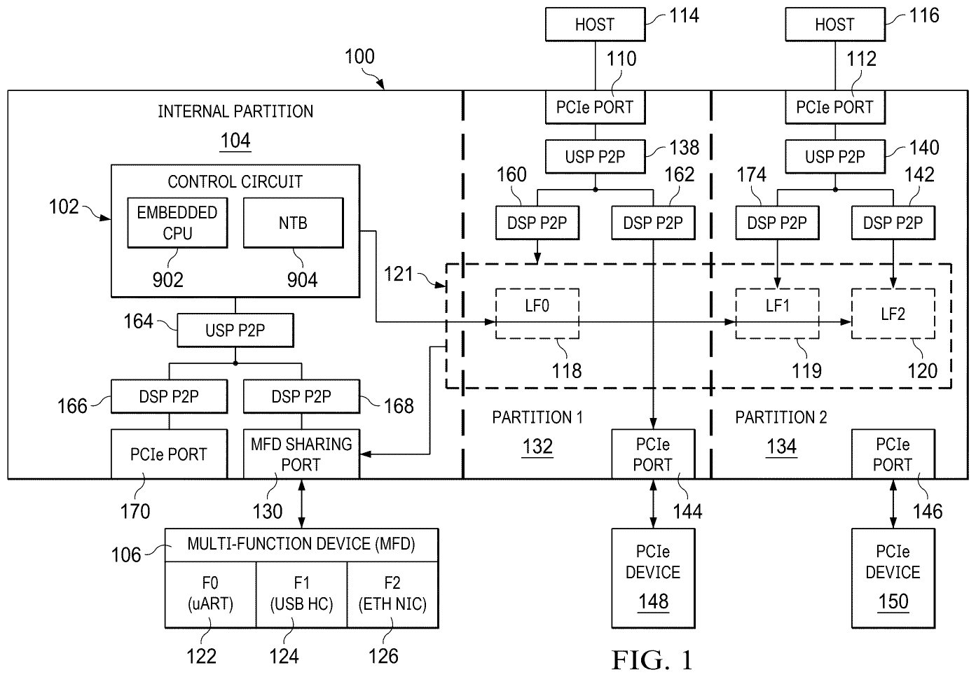

FIG. 1 is an illustration of a system 100, according to examples of the present disclosure. System 100 may be implemented in any suitable manner, such as by a PCIe switch. System 100 may include a control circuit 102. Furthermore, system 100 may include any suitable number and kind of PCIe ports 110, 112, 130, 144, 146. System 100 may be configured to connect to any suitable number and kind of PCIe hosts 114, 116 and PCIe devices 148, 150. System 100 may be configured to share access to any suitable number and kind of MFD 106 to any suitable number and kind of hosts 114, 116. Although a single instance of MFD 106 is shown, and two hosts 114, 116 are shown in FIG. 1, any suitable number and kind of MFDs 106 and hosts 114, 116 may be used.

PCIe ports 110, 112, 130, 144, 146 may be configured in any suitable manner. PCIe ports 110, 112 may be configured to connect to a given host among hosts 114, 116. PCIe ports 110, 112 may be upstream PCIe ports. MFD sharing port 130 may be configured to connect to MFD 106. Hosts 114, 116 may share access to MFD 106 through MFD sharing port 130. PCIe ports 144, 146 may be downstream PCIe ports to connect to PCIe devices 148, 150. MFD sharing port 130 may be a downstream PCI port.

System 100 may be configured to facilitate MFD 106 and the functions therein to be shared by hosts 114, 116. MFD 106 may include any suitable number and kind of physical functions (PFs). In the example of FIG. 1, PFs may include FO UART 122, F1 universal serial bus (USB) host controller (HC) 124, and F2 Ethernet Network Interface Controller (NIC) 126. The PFs may be functions that share one or more physical resources of MFD 106 and may be separately assigned to an individual host such as hosts 114, 116, wherein respective hosts understand or perceive that it is the sole operator of the corresponding PF 122, 124, 126 or MFD 106. By assigning different ones of PFs 122, 124, 126 to different hosts 114, 116, MFD 106 may effectively be shared by hosts 114, 116 even though such sharing of an MFD across multiple PCIe hosts may not be allowed under the PCIe specification.

System 100 may be configured to cause MFD 106 to be shared by hosts 114, 116. Specifically, such sharing may be enabled by control circuit 102. Control circuit 102 may be implemented in any suitable manner such as analog circuitry, digital circuitry, instructions for execution by a processor, a field programmable gate array, an application specific integrated circuit, programmable logic, an embedded processor, firmware, or any suitable combination thereof. Control circuit 102 may include or be communicatively coupled to an article of manufacture. The article of manufacture may be implemented as a non-transitory memory such as read only memory, random access memory, or any other suitable memory. The article of manufacture may include instructions. The instructions, when loaded and executed by a processor, may cause the processor to perform the operations of control circuit 102 as described in the present disclosure.

Control circuit 102 may be configured to provide interdomain bridging of PCIe transactions between hosts 114, 116 and PFs 122, 124, 126. An interdomain bridge 121 is illustrated in FIG. 1 for illustrative purposes, although such an interdomain bridge 121 may be implemented by different portions of control circuit 102 as described in subsequent figures.

System 100 may include an upstream PCIe-to-PCIe (P2P) bridge 164 coupled to control circuit 102. Upstream P2P bridge 164 and downstream P2P bridge 166 may provide access to PCIe port 170. Control circuit 102 may route data to PCIe port 170 via upstream P2P bridge 164 and downstream P2P bridge 166

Control circuit 102 may be configured to enumerate MFD 106 in a PCIe partition internal to system 100 referred to as internal partition 104. Respective hosts 114, 116 may be assigned other partitions, such as a first partition 132 and a second partition 134. A given host may perceive only its assigned partition and activities and entities in other partitions may not be visible or transparent to such a host. In the example of FIG. 1, internal partition 104 might not be accessible or visible to either of hosts 114, 116. First partition 132 assigned to host 114 might not be accessible or visible to host 116. Partition 134 assigned to host 116 might not be accessible or visible to host 114.

MFD sharing port 130 may connect control circuit 102 to MFD 106 and internal partition 104. Downstream PCIe port 144 may connect host 114 to PCIe device 148 through first partition 132. Downstream PCIe port 146 may connect host 116 to PCIe device 148 through second partition 134.

Control circuit 102 may be configured to emulate virtual or logical functions (LF) based on respective PFs. The LF may be hosted in a corresponding partition of system 100. For example, control circuit 102 may emulate PF0 122 as LF0 118 in first partition 132 for host 114. Host 114 may perceive LF0 118 as a first PCIe device that has attached to host 114 through PCIe port 110. Similarly, control circuit 102 may be configured to emulate PF1 124 as LF1 119 and to emulate PF2 126 as LF2 120 in second partition 134 assigned to host 116. Host 116 may perceive LF1 119 and LF2 120 as a second PCI device and a third PCI device that have been attached to host 116 through PCIe port 112.

Example implementations of host 114 may be an x86 or ARM-based CPU with PCIe hosts. Examples of MFD 106 may include a PCIe device with multiple functions like 3 UART instances, a PCIe device with multiple functions like USB Host controller, Ethernet NIC.

In system 100, respective hosts 114, 116 may be given respective partitions 132, 134 in system 100. If a given host wants to access MFD 106, in effect the given host must cross a partition boundary to a partition hosted by a different host-including MFD 106. Control circuit 102 may regulate access by host processors to other partitions that are accessed through logical functions. Control circuit 102 may apply a set of rules to cross such a partition boundary. Some rule examples include translation of Requester ID in Transaction Layer Packets (TLPs), translation of Completer ID in TLPs, or translation of memory address in TLPs. Any suitable number and kind of rules can be used.

For respective MFDs, PFs may be assigned to respective hosts as required. For example, such assignment may include that PF F0 122 may be assigned to host 114, and PF F1 124 and PF F2 126 may be assigned to host 116. PF F1 124 may be a USB hardware controller and PF F2 126 may be an Ethernet network interface card (NIC).

A set of hardware rules may be used for access between partition boundaries, from, for example, first partition 132 through internal partition 104 to provide configuration or access between host 114 and MFD 106. The rules table may be of sufficient size to handle the various access and configuration permutations between hosts, PFs, and MFD.

Control circuit 102 may be configured to enumerate LFs 118, 119, 120 to hosts 114, 116 as a PCIe endpoint. Configuration transactions may be handled by hypervisor firmware within control circuit 102 running on an embedded processor, discussed in further detail below. Control circuit 102 may be configured to maintain an illusion to hosts 114, 116 that a given such host may own the PCIe endpoint, which is in fact a bridged access to one of PFs 122, 124, 126 in MFD 106, and are not necessarily stand-alone PCIe endpoints. Moreover, control circuit 102 may respond to functions while taking into account other functions operating on other PFs. For example, if host 114 instructs LF0 118 to power down, MFD 106 might not actually be powered down, and control circuit 102 may respond with an acknowledgement but not actually power down MFD 106.

In one example, all data transactions may be handled in hardware by control circuit 102, with no impact on throughput. In one example, in firmware, all configuration transactions may be redirected by hardware in control circuit 102 to a hypervisor firmware running on an embedded processor. Such hypervisor firmware may be operating within or outside of control circuit 102. The hypervisor firmware may maintain the illusion that respective hosts own a PCIe device which is bridged to the respective PF. For example, if one host issue a ‘power down’ instruction to what it believes to be its device, the hypervisor firmware may respond with an acknowledgement but does nothing if other processors are still active.

Although a single MFD 106 and three PFs 122, 124, 126 therein are shown in FIG. 1, any suitable number of MFDs may be connected to system 100 through respective downstream ports, and any suitable number of PFs may reside on a given MFD. MFDs may otherwise be configured to be connected to a single PCIe host and share the various functionalities of different physical functions to different operating systems running in virtualized environment in the same host. Examples of the present disclosure may allow multiple PCIe Hosts to share virtualized MFD functions, without using specialized host software in hosts 114, 116.

Control circuit 102 may utilize Non-Transparent Bridging (NTB), an interdomain bridging technique to support multiple partitions, an embedded CPU that runs a controller firmware that includes an embedded hypervisor firmware, and a multi host to interdomain bridge 121. Control circuit 102 may include these elements or may be communicatively coupled to these elements.

Host 114 may access upstream PCIe port 110 in first partition 132 of system 100, which may be connected to a downstream PCIe port 144. Upstream PCIe-to-PCIe (P2P) bridge 138, downstream P2P bridge 160 and downstream P2P bridge 162 may be used to connect upstream PCIe port 110 to downstream PCIe port 144.

Host 116 may access upstream PCIe port 112 in second partition 134 of system 100, which may be connected to a downstream PCIe port 146. Upstream P2P bridge 140, downstream P2P bridge 174 and downstream P2P bridge 142 may be used to connect upstream PCIe port 112 to downstream PCIe port 146.

Control circuit 102 may access MFD 106 from a third partition of system 100, which may be internal partition 104. Partitions 104, 132, 134 may be separate partitions. Access to resources of other partitions may be made by an interdomain bridge 121, controlled by control circuit 102.

Host 114 may access another downstream PCIe port 144, to which another downstream device such as PCIe device 148 may be connected. Access by host 114 to PCIe device 148 may be made through USP P2P bridge 138 to DSP P2P bridge 139 to downstream PCIe port 144.

Similarly, host 116 may access another downstream PCIe port 146, to which another downstream device such as PCIe device 150 may be connected. Access by host 116 to PCIe device 150 may be made through USP P2P bridge 140 to DSP P2P bridge 142 to downstream PCIe port 146.

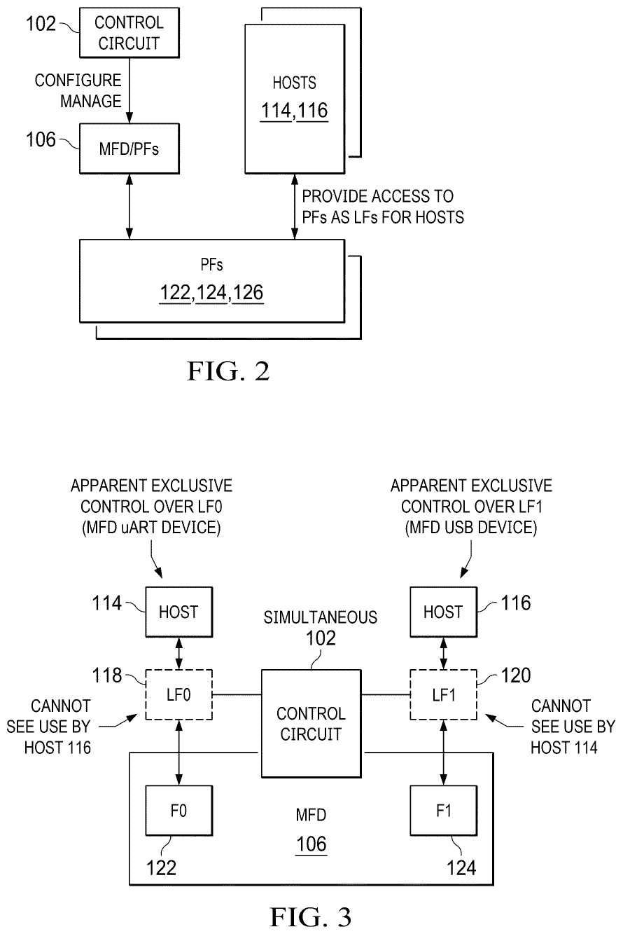

FIG. 2 is an illustration of operation of system 100 to configure and manage MFD 106, according to examples of the present disclosure. Control circuit 102 may issue management or configuration commands to PFs 122, 124, 126 of MFD 106. Such commands are discussed further below. Such commands may configure usage of different PFs 122, 124, 126 for use by various hosts 114, 116. Then, when access is requested of MFD 106 by hosts 114, 116, access to the perceived LFs 118, 119, 120 by hosts 114, 116 may be facilitated by control circuit 102.

FIG. 3 is an illustration of operation of system 100 to emulate PFs as individual PCIe devices to hosts 114, 116 to share MFD 106 to hosts 114, 116 simultaneously, according to examples of the present disclosure.

Host 114 may have apparent exclusive control over PF F0 122 through access of LF0 118, which may be a virtualized or emulated PCIe device function by control circuit 102. PF F0 122 maybe a UART. LF0 118 may be mapped to PF F0 122 in MFD 106. Simultaneously, host 116 may have apparent exclusive control over PF F1 124 and PF 126 (not shown) through access of LF1 119 and LF2 120, which may be virtualized or emulated PCIe device functions by control circuit 102. LF1 may be mapped to PF F1 124 and LF2 may be mapped to F2 126 in MFD 106.

Host 114 might not be able to see the use or access of MFD 106 by host 116. Host 116 might not be able to see the use or access of MFD 106 by host 114. This may be accomplished through control circuit 102 emulating access of MFD 106 to hosts 114, 116 such that respective hosts 114, 116 perceive attachment of a PCIe device and use of a function therein to its own downstream port with no visibility into other partitions. Control circuit 102 effectively indicates to respective hosts 114, 116 that the respective host has exclusive control over a given PF in MFD 106. The access by a given host 114, 116 to MFD 106 is non-transparent to other hosts.

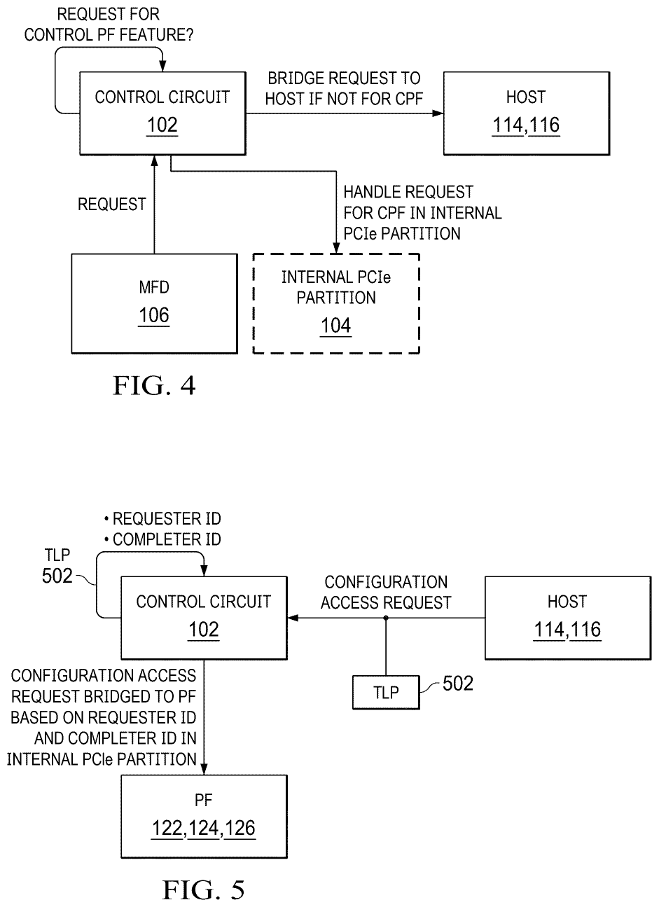

FIG. 4 is an illustration of operation of control circuit 102 to bridge requests from a given MFD 106, according to examples of the present disclosure.

Control circuit 102 may receive a request from MFD 106. Control circuit 102 may determine whether the request is for a control PF feature. A control PF may include a PF that controls or manages features of other PFs or functions in MFD 106 along with controlling and managing itself. Examples of a control PF may include physical function 0 in a MFD.

If the request from MFD 106 is a request for a control PF, then the request may be handled within internal partition 104. Otherwise, the request may be bridged to the respective host 114, 116 on the basis of the PF from which the request is sent.

FIG. 5 is an illustration of operation of control circuit 102 to handle communication from a given host, according to examples of the present disclosure.

Control circuit 102 may receive a communication from a given host 114, 116. The request may include a transaction layer packet (TLP) 502, and may include a configuration access request.

Control circuit 102 may determine a requester identifier and a completer identifier in the TLP, and use these to bridge the TLP, a configuration access request from the given host to a respective PF in MFD 106. This bridging may be performed through internal partition 104. A requester identifier may be a combination of a requesting host's bus number, device number, and function number. A completer identifier may be a combination of the completing host's bus number, device number, and function number.

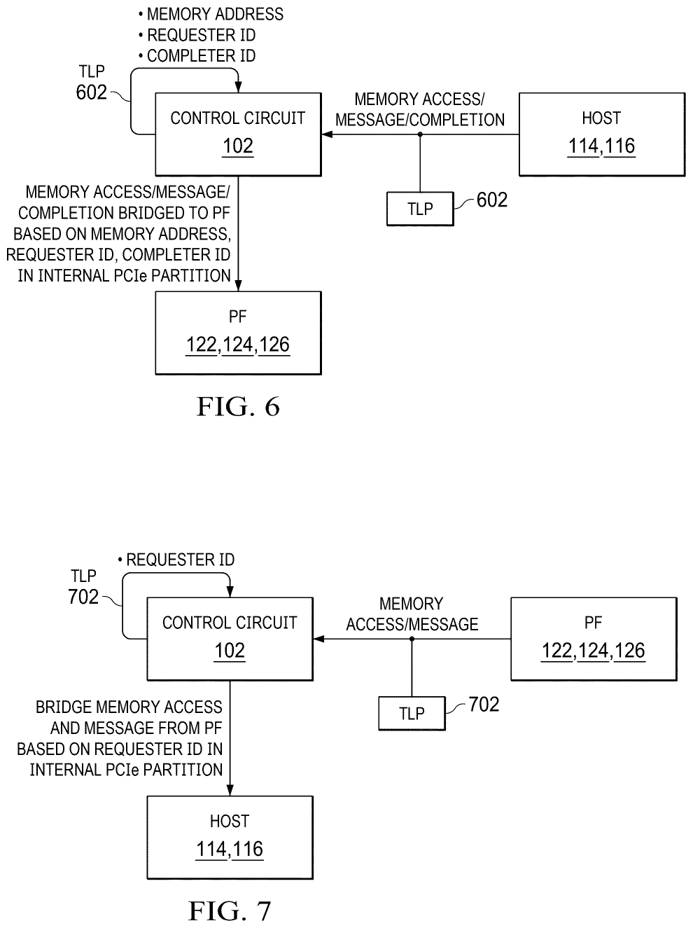

FIG. 6 is another illustration of operation of control circuit 102 to handle communication from a given host, according to examples of the present disclosure.

Control circuit 102 may receive a communication from a given host 114, 116. The request may include a TLP 602, which may be a memory access request, message, or completion request.

Control circuit 102 may determine a memory address such as a specific location in the address space of a PCIe device, a requester identifier, and a completer identifier in the TLP, and use these to bridge the TLP, a memory access, message, or completion request from the given host to a respective PF. This bridging may be performed through internal partition 104.

FIG. 7 is yet another illustration of operation of control circuit 102 to handle communication from a respective PF 122, 124, 126, according to examples of the present disclosure.

Control circuit 102 may receive a communication from a given PF 122, 124, 126. The request may include a TLP 702, which may be a memory access request or message.

Control circuit 102 may determine a requester identifier in the TLP, and use this to bridge the TLP, a memory access request or message from the given PF to a respective host. This bridging may be performed through internal partition 104.

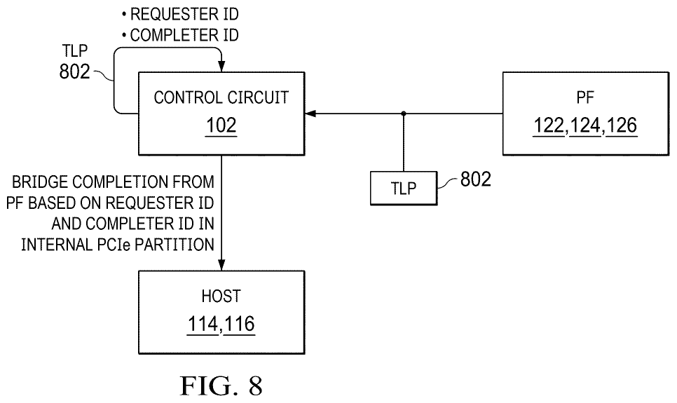

FIG. 8 is still yet another illustration of operation of control circuit 102 to handle communication from a respective PF 122, 124, 126, according to examples of the present disclosure.

Control circuit 102 may receive a communication from a given PF 122, 124, 126. The request may include a TLP 802, which may be a completion request.

Control circuit 102 may determine a requester identifier and a completer identifier in the TLP, and use these to bridge the TLP, a completion request from the given PF to a respective host. This bridging may be performed through internal partition 104.

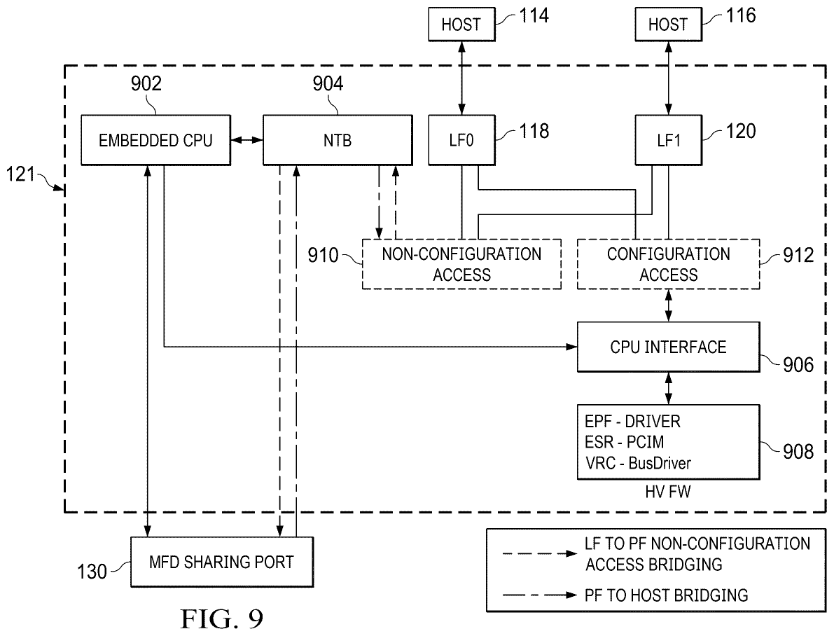

FIG. 9 is a more detailed illustration of interdomain bridge 121, according to examples of the present disclosure.

Control circuit 102 may include or may be communicatively coupled to a non-transparent bridging circuit (NTB) 904 and an embedded central processing unit (CPU) 902. Embedded CPU 902 may be configured to run hypervisors, firmware, or any other suitable instructions. NTB circuit 904 may be implemented in any suitable manner such as analog circuitry, digital circuitry, instructions for execution by a processor, a field programmable gate array, an application specific integrated circuit, programmable logic, an embedded processor, firmware, or any suitable combination thereof. Operations of embedded CPU 902 may be performed by NTB circuit 904, and vice-versa, in different implementations. Embedded CPU 902 and NTB circuit 904 may implement interdomain bridge 121, and therein emulate PFs as LF0 118 and LF1 119.

Host 114 may connect to LF0 118 through an upstream port 160. Access of LF0 118 may in turn be routed through or by NTB circuit 904 to MFD sharing port 130 to MFD 106. Access of LF1 119 may in turn be routed through or by NTB circuit 904 to MFD sharing port 130 to MFD 106. PCIe signals may thus be routed by interdomain bridge 121 between a given host to a respective given PF through internal partition 104. These may be implemented through any suitable ports, buses, and P2Ps.

Illustrated are requests for configuration access bridging from an LF (and thus, an associated host 114, 116) to a respective PF, non-configuration access bridging from an LF to a respective PF, and requests for PF to host bridging.

Requests from host 114 through LF0 118 may be routed according to whether such requests are for configuration access 912, a non-configuration access 910, a memory access, message, or completion. Non-configuration access 910 may be routed by NTB circuit 904 to MFD sharing port 130 to MFD 106. Configuration access 912 may be handled by hypervisor firmware (HV FW) 908 running on embedded CPU 902. Configuration access 912 may involve creation and submitting of configuration access TLPs to MFD sharing port 130 to MFD 106, or bridging configuration access TLPs through NTB circuit 904 to MFD sharing port 130 to MFD 106. Such requests may be handled through a CPU interface 906 to embedded CPU 902. Configuration of system 100 may be suitably performed as a result. Similarly, host 116 may access configuration access 912 or non-configuration access 910 through LF1 120.

Hypervisor firmware 908 may include an ePF driver, eSR-PCIM driver, and a vRC bus driver.

Control circuit 102 may perform the steps of first configuring specific ports of system 100 for MFD sharing. Connection of MFD sharing port 130 may be made to internal partition 104, which is not directly connected to nor is directly visible to any of hosts 114, 116. Next, control circuit 102 may enumerate attached MFD 106 using the Virtual Root Complex bus driver (vRC-Bus driver) of HV FW 908. Control circuit 102 may perform configuration and management of MFD 106. This may be performed through the embedded Single Root PCI-manager (eSR-PCIM) of HV FW 908. Control circuit 102 may perform management of PFs 122, 124, 126 embedded PF (cPF) driver of HV FW 908. Control circuit 102 may then expose PFs as LFs to any hosts such as hosts 114, 116 to which a given PF is to be shared. Control circuit 102 may then handle configuration access from hosts 114, 116 to the LFs through a combination of forwarding requests to a control PF, forwarding requests to respective PFs, and merging PF and LF data and emulation through, for example, operation of HV FW 908. Control circuit 102 may set up and manage NTB rules for NTB circuit 904 to directly bridge requests such as DMA, memory space access and interrupt processing between a host and a PF, with reduced intervention from a CPU of system 100.

As shown in FIG. 1, a given host 114, 116 may communicate with a given PCIe device 148, 150, or with MFD 106. Communication by a given host 114, 116 with a PCIe device 148, 150 attached to a same partition 132, 134 as the respective host 114, 116 may be referred to as a pass through mode of operation. Communication by a given host 114, 116 with a shared MFD 106 in a different partition such as internal partition 104, which is not connected to any external PCIe host and managed by a control circuit 102, may be referred to as an MFD sharing mode.

The pass through mode of operation may be implemented according to the PCIe specification.

In the MFD sharing mode, enumeration, resource allocation for memory space, interrupts, configuration, and power management of downstream devices such as MFD 106 may be managed and performed by control circuit 102, and in particular, HV FW 908. Enumeration and configuration of PCIe devices in the MFD sharing mode may be performed according to standard PCIe functions through an internal partition. PCIe endpoints with more than one physical function, such as MFD device 106, may be supported at the respective downstream port such as MFD sharing port 130. When control circuit 102 detects unsupported PCIe devices (non-endpoints like switches and endpoints that do not have multiple functions) at a port, the port operation may be switched from MFD sharing mode to pass through mode, until disconnection of these devices, at which time the port is again switched to MFD sharing mode.

In the MFD sharing mode, interdomain bridge 121, under control of control circuit 102, may perform connections between LFs 118, 119, 120, hosts 114, 116 and ports 130, 170.

The vRC bus driver in HV FW 908 may be a virtual root complex bus driver, and may be responsible for enumeration, resource allocation for memory space and interrupts, configuration, and power management of PCIe devices attached to MFD sharing port 130.

The eSR-PCIM may be an embedded single root PCI resource manager, and may be responsible for configuration and management of the resources required by MFDs.

The ePF Driver may be an embedded physical function driver and may be responsible for PF management, enumeration of PFs, and management of all functions shared between the PFs and Control PFs.

LFs 118, 119, 120 may appear as PCIe devices to hosts 114, 116, and may be emulated by control circuit 102. LFs 118, 119, 120 may reflect the characteristics of the underlying PFs 122, 124, 126. Most of the transactions to LFs 118, 119, 120 are forwarded and bridged to MFD 106, targeting the specific PF 122, 124, 126.

LF to PF bridging may be performed by control circuit 102. Specifically, configuration requests such as configuration read and configuration write requests from a given host 114, 116 to a given LFs 118, 119, 120 may be bridged to MFD 106 through HV FW 908 and NTB circuit 904. However, non-configuration accesses from a given host 114, 116 to a given LFs 118, 119, 120 may be bridged to MFD 106 through NTB circuit 904, and may involve minimal involvement of HV FW 908.

Communication between a given PF 122, 124, 126 to an associated LFs 118, 119, 120, such as memory read and memory write requests from MFD 106, may be bridged to LFs 118, 119, 120 through NTB circuit 904, and may involve minimal involvement of HV FW 908.

In interdomain bridge 121, MFD sharing port 130 for MFD 106 might not be exposed directly to any hosts 114, 116 outside of system 100, and the vRC Bus driver, SR-PCIM, cPF Driver components are implemented in HV FW 908 in system 100. The complexity of these elements and their operation is abstracted in system 100 and only PFs 122, 124, 126 of MFD 106 are visible (and then, only emulated as LFs) to hosts 114, 116 outside of system 100.

HV FW 908 may read the capabilities and memory space requirements of MFD 106, including the capabilities of PFs, and emulate an associated LF per PF to be shared. A given LF 118, 119, 120 may be attached to a given host 114, 116 at boot time or run-time using PCIe hot plug capability.

The ePF driver may read Base Address Registers (BAR), from the BAR0 . . . BARn register values read from PFs and the number of the PFs (n) and report the same to the respective host. LFs 118, 119, 120 might not report any I/O space requirements as part of the BARs. Fields common to multiple or all PFs like OBFF enable bits, Max_Payload_size, etc. may be virtualized by HV FW 908. The rest of a standard enumeration process per PCIe specification may be followed to enumerate and enable the PFs of the MFD.

LF to PF configuration access bridging may also be handled by control circuit 102. Type 0 configuration read requests and configuration write requests from a given host 114, 116 to an associated LF may be routed to HV FW 908 for further processing and handling. It is up to HV FW 9008 to choose to read the entire 4 kilobytes of configuration data from all the PFs at boot time and store these for processing configuration requests, or otherwise read these on demand, when the related register of the LF is accessed by a given host.

Depending on the LF register address being read or written, control circuit 102 may forward the translated access request to the Control PF when all bits of a register are implemented in the Control PF, forward the translated access request to the respective PF if all bits of the register are implemented in the respective PF, forward the translated access request for bits implemented in Control PF and merge rest of the data from the respective PF when the bits of the register are shared, or ignore configuration writes for features that are not applicable for PF or MFDs.

Wherever a configuration (implemented as registers or as bits of a register) that is shared by all PFs is written by a given host, control circuit 102 may store the data being written to in a PF context specific manner, so that this data can be processed and returned when such configuration is read by the same host in a subsequent request. This is in contrast to, for example, actually writing the configuration information to a respective PF when it is not shared with other PFs.

LFs 118, 119, 120 may be implemented with command registers to store configuration information. When a memory space enable bit in the command register of a given LF is set or cleared by a given host 114, 116, the NTB rules for memory access bridging may be updated.

When error enable bits in the command register of a given LF is set or cleared by a host, NTB rules may be updated to allow or block error messages from the specific associated PF to a given respective host.

Link management commands and power management commands to a given LF are handled primarily by HV FW 908 as there is a single link upstream of MFD 106 and hence individual PFs 122, 124, 126 cannot be given access to control the link. The same may apply to power management capabilities, management, and handling.

For features that are supported by a PF, but to which an associated LF will not or cannot provide access, such capabilities are to be masked through altering next capability pointers to be updated as part of configuration data handling of the LF.

Configuration access TLPs are routed through ID based routing, using bus number, device number, and function number (BDF) fields of TLP-based routing. When a given LF configuration request needs to be forwarded to MFD 106, HV FW 1008 may translate a completer ID of the LF (assigned in the domain of a given host) to the BDF of MFD 106 (as assigned by the vRC bus driver). Similarly, requester ID is to be translated across domain. Similarly, completer ID and requester IDs are also updated before returning completion data in response to a configuration read command.

LF to PF non-configuration accesses may also be bridged by control circuit 102.

For memory TLP requests, such memory access TLPs may be routed based on address routing. For routing a memory access TLP addressed from a given host 114, 116 to a LF 118, 119, 120, to an internal partition 104 to a PF 122, 124, 126 in MFD 106, the NTB circuit 904 may be programmed as follows. NTB rules may be established to the translate the memory address in the incoming TLP, which are in the BAR range of the LF, to the BAR range of the associated PF based on the PCIe port 110, 112 of the memory access TLP. The PCIe port is included along with the address in the translation since multiple hosts 114, 116 could have assigned the same BARs to the LF 118, 119, 120 visible to them.

Requester IDs may be translated from the host partition domain to that of the internal partition domain.

The NTB rules for memory access bridging are enabled or disabled based on a ‘memory space enable’ bit in command register of a given LF. These rules are typically implemented in hardware to avoid overhead in TLP handling.

Completion TLPs may be routed based on ID routing. These may include completion without data, completion with data, completion for locked memory read without data, and completion for locked memory read with data. For routing a completion TLP addressed from given host 114, 116 to a LF 118, 119, 120, to internal partition 104 to a given PF 122, 124, 126 in MFD device 106, NTB circuit 404 may be programmed as below. Based on the PCIe port 110, 112 of the completion TLP, the completer ID may be translated from the domains of host partitions 132, 134 to that of the domain of internal partition 104.

Message TLPs may be routed by NTB circuit 904 as configured by HV FW 908. However, power management message TLPs, including slot power limit messages, may be handled may be handled by HV FW 908 as targeted to LFs 118, 119, 120 not bridged further when multiple PFs 122, 124, 126 are active, as multiple PFs 122, 124, 126 may be present and hence power management of individual PFs 122, 124, 126 might not be possible.

Vendor defined message TLPs may be translated from host domain partitions 132, 134 to internal partition 104.

Access from PFs 122, 124, 126 to LFs 118, 119, 120 and elements upstream thereof may be handled by control circuit 102.

Memory TLP bridging may be performed by control circuit 102. Memory requests typically originate from MFD 106 during bus master DMA transfers and MSI/MSI-X interrupts. Though memory TLPs are intended to be routed based on address, control circuit 102 may use the requester ID in the TLP to identify the PF 122, 124, 126 from which the request originated. For routing a memory access TLP from a given PF 122, 124, 126 to internal partition 104, to the upstream of a respective LF 118, 119, 120, NTB circuit 904 may be programmed as follows. In case the requester ID matches the BDF of the Control PF, the memory read or write request is handled by the ePF-driver in HV FW 908 for features common to all PFs and is not to be forwarded or bridged further. Otherwise, the memory read or memory write request is bridged to the LF 118, 119, 120 respective to host 114, 116 with which the PF 122, 124, 126 is bridged, with the requester ID field updated to that of the LF 118, 119, 120. Note that the address might not be translated, as DMA transfers are typically set up by programming the device DMA controller registers, which are accessible to a host (and the host driver) in the BAR space. The context of these DMA registers and the data that goes into these DMA registers might not be known to system 100. Hence, though MFD 106 operates in the vRC domain, the DMA transfers (such as memory read requests) that MFD 106 initiates refer to the memory address of the actual host partition 132, 134 that it is connected to. Hence, the address might not be translated.

Control circuit 102 may bridge completion TLPs that originate from MFD 106 are based on the completer ID field in the completion header. For routing a completion TLP from a given PF to internal partition 104, to the upstream of LF 118, 119, 120, NTB circuit 904 may be programmed as follows. In case the completer ID matches the BDF of a Control PF for features common to all PFs, the completion may be handled by the cPF-driver in HV FW 1008. Otherwise, the completion TLP may be bridged to the LF 118, 119, 120 respective to the host 114, 116 with which the PF 122, 124, 126 is bridged, with the completer ID field updated to that of the LF 118, 119, 120 and the requester ID field updated to that of the domain of the host internal partition 104 (as stored by LF 118, 119, 120).

Message TLPs bridging may be performed by NTB circuit 904 as configured by HV FW 1008.

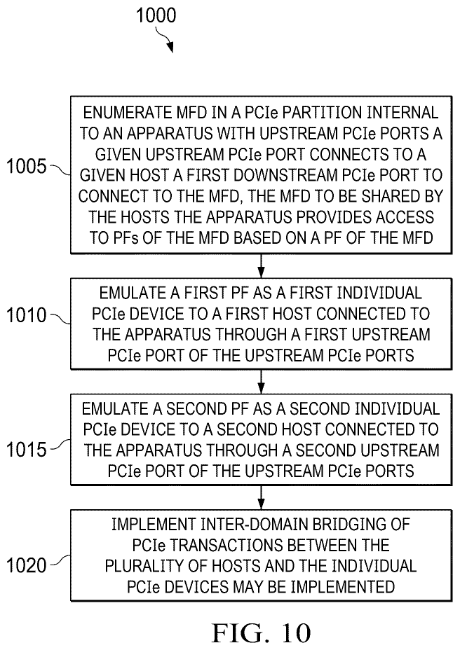

FIG. 10 is an illustration of an example method 1000, according to examples of the present disclosure. Method 1000 may begin at any suitable point. Method 1000 may include more or less steps than shown in FIG. 10. The steps of method 1000 may be performed in any suitable order, and steps of method 1000 may optionally be omitted, repeated, performed in parallel, or performed recursively. Method 1000 may be implemented by any suitable portion of FIGS. 1-9, such as system 100 and in particular control circuit 102, HV FW 908, and NTB circuit 904.

At 1005, an MFD may be enumerated in a PCIe partition internal to an apparatus. The apparatus may include a plurality of upstream PCIe ports, a given upstream PCIe port to connect to a given host of a plurality of hosts, and a first downstream PCIe port to connect to the MFD, wherein the MFD is to be shared by the plurality of hosts and the apparatus is to provide access to a plurality of PFs of the MFD.

At 1010, a first PF of the plurality of PFs may be emulated as a first individual PCIe device to a first host of the plurality of hosts, wherein the first host is connected to the apparatus through a first upstream PCIe port of the upstream PCIe ports.

At 1015, a second PF of the plurality of PFs may be emulated as a second individual PCIe device to a second host of the plurality of hosts, the second host connected to the apparatus through a second upstream PCIe port of the upstream PCIe ports.

At 1020, inter-domain bridging of PCIe transactions between the plurality of hosts and the individual PFs may be implemented.

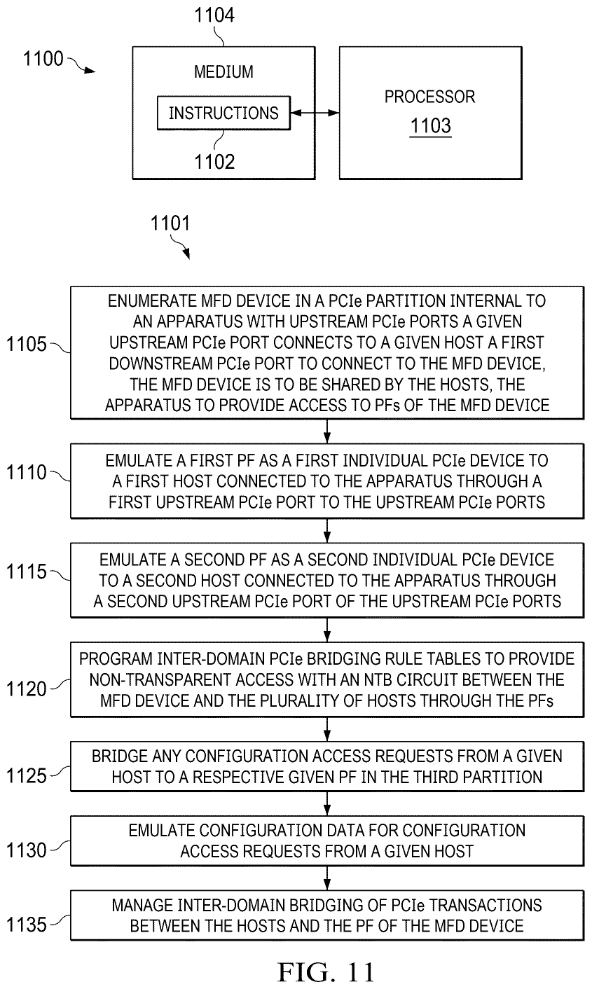

FIG. 11 is an illustration of an example article of manufacture 1100 and an example method 1101 performed by such an article of manufacture 1200, according to examples of the present disclosure. Article of manufacture 1100 may include a non-transitory machine-readable medium 1104 that may include instructions 1102, which when loaded and executed by a processor 1103, may perform any suitable operations of the present disclosure. Such operations may include method 1000 or 1101, the operations of suitable portions of FIGS. 1-9 such as system 100 and in particular control circuit 102, HV FW 908, and NTB circuit 904. Processor 1103 may be implemented by any suitable circuitry or processor such as embedded processor 902. Medium 1104 may be implemented in any suitable manner such as by a memory.

Method 1101 may be a more detailed illustration of method 1000. Method 1101 may begin at any suitable point. Method 1101 may include more or less steps than shown in FIG. 11. The steps of method 1100 may be performed in any suitable order, and steps of method 1101 may optionally be omitted, repeated, performed in parallel, or performed recursively. Method 1101 may be implemented by any suitable portion of FIGS. 1-10, such as system 100 and in particular control circuit 102, HV FW 908, and NTB circuit 904, or by processor 1103 executing instructions 1102.

At 1105, an MFD may be enumerated in a PCIe partition internal to an apparatus. The apparatus may include a plurality of upstream PCIe ports, a given upstream PCIe port to connect to a given host of a plurality of hosts, and a first downstream PCIe port to connect to the MFD, wherein the MFD is to be shared by the plurality of hosts and the apparatus is to provide access to a plurality of PFs of the MFD based on advertised capabilities within the PF of the MFD.

At 1110, a first PF of the plurality of PFs may be emulated as a first individual PCIe device to a first host of the plurality of hosts, wherein the first host is connected to the apparatus through a first upstream PCIe port of the upstream PCIe ports.

At 1115, a second PF of the plurality of PFs may be emulated as a second individual PCIe device to the first or second host of the plurality of hosts, the second host connected to the apparatus through a second upstream PCIe port of the upstream PCIe ports.

At 1120, inter-domain PCIe bridging rule tables may be programmed to provide non-transparent access between the MFD and the plurality of hosts through the PFs.

At 1125, any configuration access requests from a given host to a respective given PF may be bridged through the third partition.

At 1130, configuration data for configuration access requests from a given host may be emulated.

At 1135, inter-domain bridging of PCIe transactions between the plurality of hosts and the PF of the MFD may be managed as necessary.

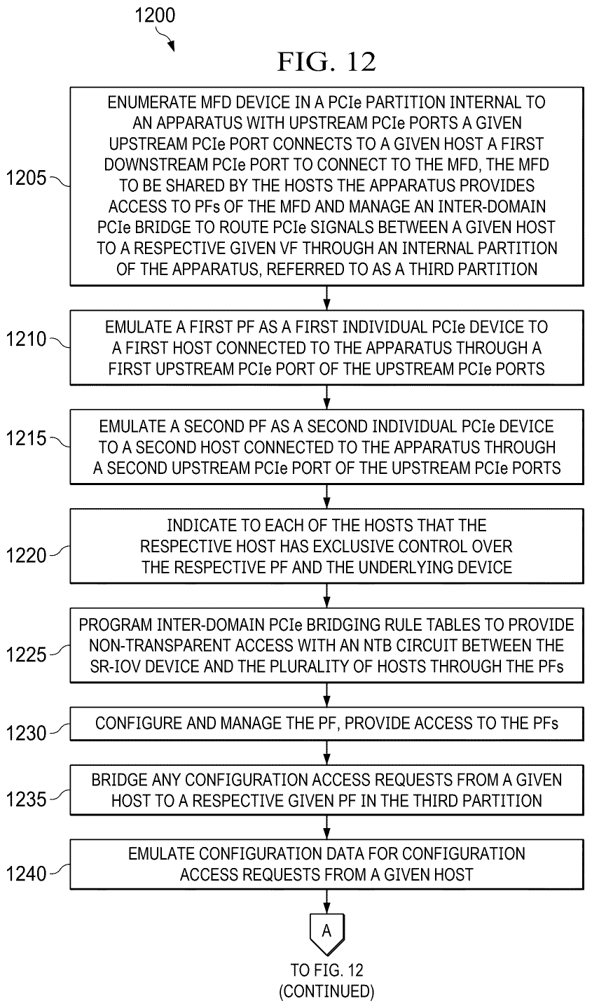

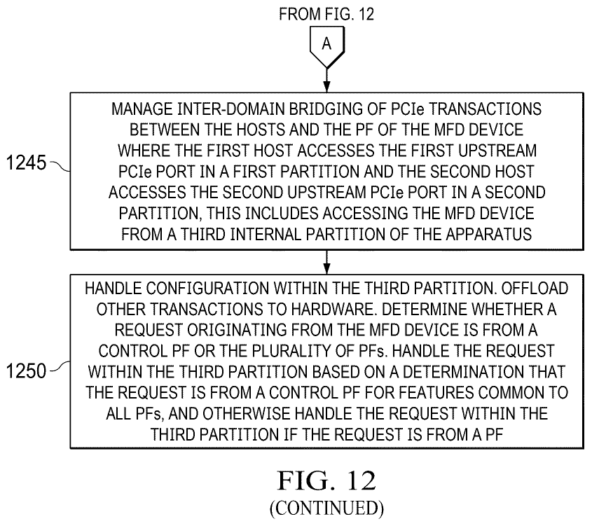

FIG. 12 is an illustration of a method 1200 that may be a more detailed illustration of method 1101, according to examples of the present disclosure.

At 1205, an MFD may be enumerated in a PCIe partition internal to an apparatus. The apparatus may include a plurality of upstream PCIe ports, a given upstream PCIe port to connect to a given host of a plurality of hosts, and a first downstream PCIe port to connect to the MFD, wherein the MFD is to be shared by the plurality of hosts and the apparatus is to provide access to a plurality of PFs of the MFD based on advertised capabilities within the PF of the MFD.

An inter-domain PCIe bridge may be programmed and managed to route PCIe signals between a given host to a respective given PF through an internal partition of the apparatus, referred to as a third partition.

At 1210, a first PF of the plurality of PFs may be emulated as a first individual PCIe device to a first host of the plurality of hosts, wherein the first host is connected to the apparatus through a first upstream PCIe port of the upstream PCIe ports.

At 1215, a second PF of the plurality of PFs may be emulated as a second individual PCIe device to a second host of the plurality of hosts, the second host connected to the apparatus through a second upstream PCIe port of the upstream PCIe ports. The PFs may be emulated as the devices to the hosts to share the MFD to the hosts simultaneously.

At 1220, indicate to hosts that the respective host has exclusive control over the respective PF in the underlying device.

At 1225, inter-domain PCIe bridging rule tables may be programmed to provide non-transparent access between the MFD and the plurality of hosts through the PFs. This may include non-transparent access to the MFD for the plurality of hosts through the PFs.

At 1230, the PFs may be configured and managed, and access to the PFs through the internal partition may be provided.

At 1235, any configuration access requests from a given host to a respective given PF may be bridged through the third partition after determining the configuration register address.

At 1240, configuration data for configuration access requests from a given host may be emulated after determining the configuration register address.

At 1245, inter-domain bridging of PCIe transactions between the plurality of hosts and the PF of the MFD may be managed as necessary. Where the first host is to access the first upstream PCIe port in a first partition of the apparatus and the second host is to access the second upstream PCIe port in a second partition of the apparatus, this may include accessing the MFD from a third partition of the apparatus, wherein the first partition, the second partition, and the third partition of the apparatus are separate partitions.

At 1250, such transactions may include configuration transactions that are handled within the third partition. Other transactions may be offloaded to hardware. Handling such transactions may include determining whether a request originating from the MFD is from the Control PF or from one of the plurality of the PFs, bridging the request to a respective host based on a determination that the request originating from the MFD is from one of the plurality of PFs, and otherwise, based on a determination that the request originating from the MFD is from the Control PF for features common to all PFs, handling the request within the third partition. Handling such transactions may include determining a first requester identifier and a first completer identifier of a first transaction layer packet to bridge a configuration access request from the given host of the plurality of hosts to a respective PF in the third partition.

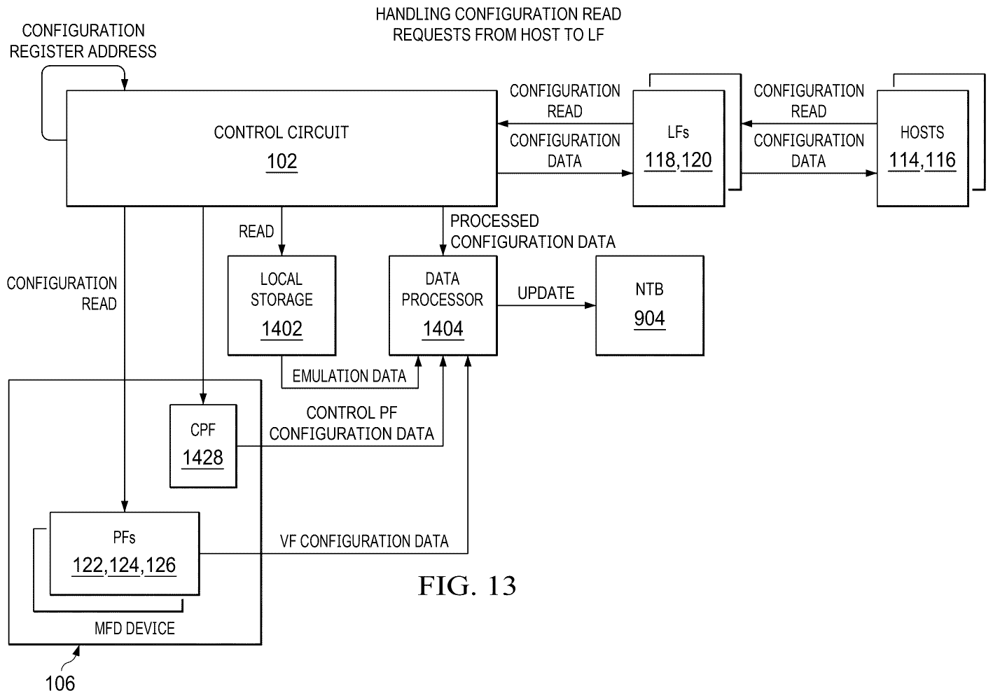

FIG. 13 is an illustration of operation of control circuit 102 to handle configuration read requests from a given host 114, 116 to a LF 118, 119, 120, according to examples of the present disclosure. Configuration read requests may include a transaction to read configuration registers of functions within devices.

One of hosts 114, 116 may issue a configuration request that is a read to an associated one of LFs 118, 119, 120.

The receiving LF 118, 119, 120 may provide the configuration read request to control circuit 102.

Control circuit 102 may be configured to determine from where the configuration read request will need input. For example, control circuit 102 may determine whether the requested configuration data needs input from one or more of a local storage 1402, or a respective one of PFs 122, 124, 126, or a Control PF 1428. This determination may be based on the configuration register address of the configuration read requests.

If the configuration register address indicates that the configuration read request will need input from local storage, then control circuit 102 may retrieve configuration emulation data stored in local storage 1402 for processing in a data processor 1404.

If the configuration register address indicates that the configuration read request will need input from a control PF 1428, then control circuit 102 may retrieve PF configuration data from the Control PF for processing in data processor 104.

If the configuration register address indicates that the configuration read request will need input from one of PFs 122, 124, 126, then control circuit 102 may retrieve PF configuration data from the identified one of PFs 122, 124, 126.

The input may be processed in data processor 1404. Processed configuration data may be returned to control circuit 102. Processed configuration data may be used for multi-host emulation of MFD 106, so that a given host 114, 116 may have its access bridged through the respective LF 118, 119, 120. NTB rules in NTB circuit 904 may be updated. Data processor 1404 may apply arithmetic and logic operations on the data retrieved from one or more of local storage 1402, and PFs 122,124,126 to finalize the processed configuration data.

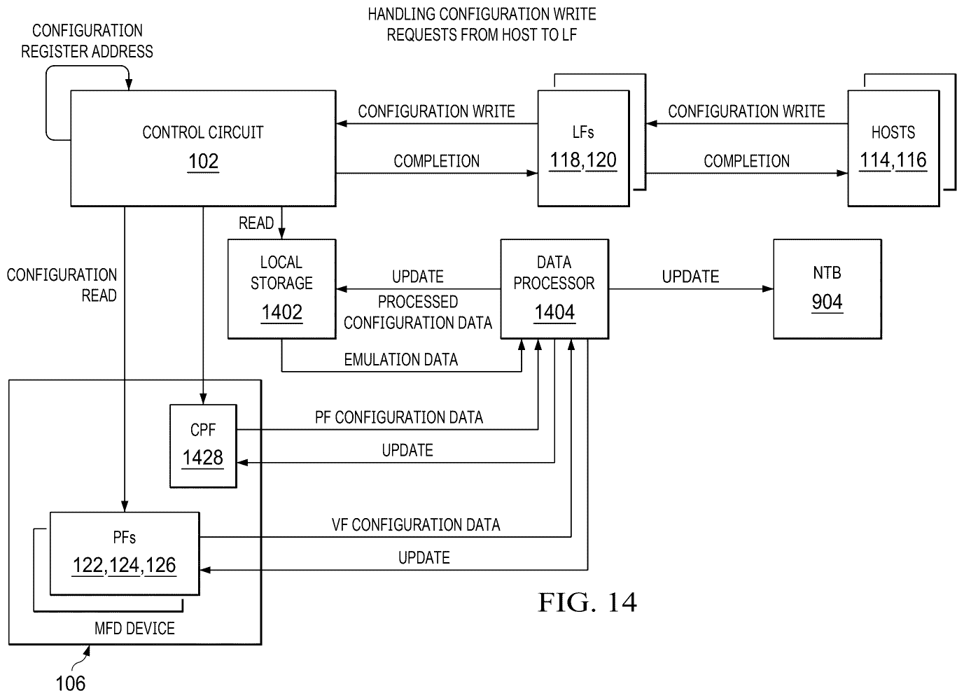

FIG. 14 is an illustration of operation of control circuit 102 to handle configuration write requests from a given host 114, 116 to a LF 118, 119, 120, according to examples of the present disclosure. Configuration write requests may include a transaction to write configuration registers of functions within devices.

One of hosts 114, 116 may issue a configuration request that is a write to an associated one of LFs 118, 119, 120.

The receiving LF 118, 119, 120 may provide the configuration write request to control circuit 102.

Control circuit 102 may be configured to determine from where the configuration write request will need input and to where the updated configuration data is to be written. For example, control circuit 102 may determine whether the requested configuration data write needs input from one or more of a local storage 1402, or a respective one of PFs 122, 124, 126, or the control PF 1428. This determination may be based on the configuration register address of the configuration read requests.

If the configuration register address indicates that the configuration write request will need input from local storage, then control circuit 102 may retrieve configuration emulation data stored in local storage 1402 for processing in a data processor 1404.

If the configuration register address indicates that the configuration write request will need input from a control PF 1428, then control circuit 102 may retrieve PF configuration data for processing in data processor 104.

If the configuration register address indicates that the configuration write request will need input from one of PFs 122, 124, 126, then control circuit 102 may retrieve PF configuration data from the identified one of PFs 122, 124, 126.

The input may be processed in data processor 1404. Data processor 1404 may apply arithmetic and logic operations on the data retrieved from one or more of local storage 1402, PFs 122, 124, 126 to finalize the processed configuration data. Processed configuration data may be written to one or more of local storage 1402, PFs 122, 124, 126 if the configuration register address addresses a valid register supported by respective LF. Processed configuration data may be used for multi-host emulation of MFD 106, so that a given host 114, 116 may have its access bridged through the respective LF 118, 119, 120. NTB rules in NTB circuit 904 may be updated. Control circuit 102 may return completion status to given host 114, 116 through the respective LF 118, 119, 120.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as non-transitory communications media and/or any combination of the foregoing.

Although the present disclosure has been described in detail, it should be understood that various changes, substitutions, and alterations can be made hereto without departing from the spirit and the scope of the disclosure as defined by the appended claims.

1. A system, comprising:
a plurality of upstream PCIe ports, a given upstream PCIe port to connect to a given host of a plurality of hosts;
a first downstream PCIe port to connect to a multi-function device (MFD), the MFD to be shared by the plurality of hosts, the system to provide access to a plurality of physical functions (PF) of the MFD as a plurality of logical functions (LF) in individual PCIe devices to the plurality of hosts; and
a control circuit configured to:
enumerate the MFD;
emulate a first PF of the plurality of PFs of the MFD as a first individual PCIe device to a first host of the plurality of hosts, the first host connected to the system through a first upstream PCIe port of the plurality of upstream PCIe ports;
emulate a second PF of the plurality of PFs of the MFD as a second individual PCIe device to a second host of the plurality of hosts, the second host connected to the system through a second upstream PCIe port of the plurality of upstream PCIe ports; and
implement inter-domain bridging of PCIe transactions between the plurality of hosts and the plurality of PFs of the MFD.

2. The system of claim 1, wherein the control circuit is configured to emulate the first and second PFs of the MFD as the first and second individual PCIe devices, respectively, to the plurality of hosts to share the MFD to the plurality of hosts simultaneously.

3. The system of claim 2, wherein the control circuit is to share the MFD to the plurality of hosts simultaneously while indicating to respective hosts of the plurality of hosts that the given host has control over a given LF.

4. The system of claim 1, wherein the control circuit is configured to provide non-transparent access to the MFD for the plurality of hosts through the LFs.

5. The system of claim 1, wherein:
the first host is configured to access the first upstream PCIe port in a first partition of the system;
the second host is configured to access the second upstream PCIe port in a second partition of the system; and
the control circuit is configured to enumerate the MFD from a third partition, internal to the system, wherein the first partition, the second partition, and the third partition of the system are separate partitions.

6. The system of claim 5, wherein the first host is configured to access a second downstream PCIe port in the first partition of the system to access a downstream device.

7. The system of claim 5, wherein the control circuit is configured to implement an inter-domain PCIe bridge to route PCIe signals between a given host to a respective given PF of the MFD through the third partition.

8. The system of claim 5, wherein the control circuit is configured to bridge or emulate configuration access requests from a given host to a respective given PF of the MFD through the third partition.

9. The system of claim 5, wherein the control circuit is configured to:
determine whether a request originating from the MFD is a request that pertains to features controlled by a control PF, wherein the control PF is a PF that is configured to control and manage one or more features of other functions in an MFD
based on a determination that the request originating from the MFD is a request that pertains to features controlled by the control PF, handling the request within the third partition;
based on a determination that the request originating from the MFD is not a request that pertains to features controlled by the control PF, bridging the request to a respective host.

10. The system of claim 5, wherein the control circuit is configured to do one or more of:
determine a first requester identifier and a first completer identifier of a first transaction layer packet (TLP) to bridge a configuration access request from a given host of the plurality of hosts to a respective PF of the MFD through the third partition;
determine a memory address, a second requester identifier, and a second completer identifier of a second TLP to bridge a first memory access, a first message, and a first completion from the given host of the plurality of hosts to the respective PF of the MFD through the third partition;
determine a third requester identifier of a third TLP to bridge a second memory access and a second message from the respective PF of the MFD to the given host of the plurality of hosts through the third partition; and
determine a fourth requester identifier and a third completer identifier of a fourth TLP to bridge a second completion from the respective PF of the MFD to the given host of the plurality of hosts through the third partition.

11. The system of claim 5, wherein the control circuit is to handle a configuration read request from a given host to a respective LF through:
determination of whether requested configuration data is to be based on input from one or more of a local storage, Control PF of the MFD for the respective configuration, or a respective PF of the MFD based on a configuration register address in the configuration read request;
perform one or more of:
retrieve configuration emulation data stored in a local storage for processing in a data processor based on a determination that the requested configuration data is to use input from local storage;
retrieve first configuration data from Control PF of the MFD for the respective configuration for processing in data processor based on a determination that the requested configuration data is to use input from Control PF of the MFD; and
retrieve second configuration data from the respective PF of the MFD for processing in data processor based on the determination that the requested configuration data is to use input from respective Function of the MFD; and
process one or more of configuration emulation data, first configuration data, or second configuration data to generate processed configuration data and return the processed configuration data for multi-host emulation of the MFD to the given host, bridging through the respective LF; and
update non-transparent bridging rules.

12. The system of claim 5, wherein the control circuit is to handle a configuration write request from a given host to a respective LF through:
determination of whether configuration data is to be written based on input from one or more of a local storage, Control PF of the MFD for the respective configuration, or a respective PF of the MFD based on a configuration register address in the configuration write request;
perform one or more of:
retrieve configuration emulation data stored in a local storage for processing in a data processor based on a determination that the configuration data to be written is to use input from local storage;
retrieve first configuration data from Control PF of the MFD for the respective configuration for processing in data processor based on the determination that the configuration data to be written needs input from Control PF of the MFD; and
retrieve second configuration data from respective Function of the MFD for processing in data processor based on the determination that the configuration data to be written is to use input from the respective PF of the MFD; and
process one or more of the configuration emulation data, first configuration data, or the second configuration data of the respective PF in the data processor to finalize the processed configuration data;
write the processed configuration data to one or more of local storage, Control PF of the MFD for the respective configuration, and respective PF of the MFD if the configuration register address addresses a valid register supported by respective LF;
use processed configuration data for multi-host emulation of the MFD to the given host, bridging through the respective LF;
return a completion status to the given host through the respective LF; and
update non-transparent bridging rules.

13. A method, comprising, at an apparatus:
connecting to a given host of a plurality of hosts through plurality of upstream PCIe ports;
enumerating, through a first downstream PCIe port connected to a multi-function device (MFD), the MFD, wherein the MFD is to be shared by the plurality of hosts, and the method includes providing access to a plurality of physical functions (PF) of the MFD as a plurality of logical functions (LF) in individual PCIe devices to the plurality of hosts;
emulating a first PF of the plurality of PFs of the MFD as a first individual PCIe device to a first host of the plurality of hosts, the first host connected to the apparatus through a first upstream PCIe port of the plurality of upstream PCIe ports;
emulating a second PF of the plurality of PFs of the MFD as a second individual PCIe device to a second host of the plurality of hosts, the second host connected to the apparatus through a second upstream PCIe port of the plurality of upstream PCIe ports; and
implementing inter-domain bridging of PCIe transactions between the plurality of hosts and the plurality of PFs of the MFD.

13. The method of claim 13, comprising emulating the first and second PFs of the MFD as the first and second individual PCIe devices, respectively, to the plurality of hosts to share the MFD to the plurality of hosts simultaneously.

15. The method of claim 14, comprising sharing the MFD to the plurality of hosts simultaneously while indicating to respective plurality of hosts that the given host has control over a given LF.

16. The method of claim 13, comprising providing non-transparent access to the MFD for the plurality of hosts through the LFs.

17. The method of claim 13, wherein:
the first host is configured to access the first upstream PCIe port in a first partition of the apparatus;
the second host is configured to access the second upstream PCIe port in a second partition of the apparatus; and
the method comprises enumerating the MFD from a third partition, internal to the apparatus, wherein the first partition, the second partition, and the third partition of the apparatus are separate partitions.

18. The method of claim 17, wherein the first host is configured to access a second downstream PCIe port in the first partition of the apparatus to access a downstream device.

19. The method of claim 17, comprising implementing an inter-domain PCIe bridge to route PCIe signals between a given host to a respective given PF of the MFD through the third partition.

20. The method of claim 17, comprising emulating or bridging configuration access requests from a given host to a respective given PF of the MFD through the third partition.
